(19) United States
(12) Patent Application Publication
(10) Pub. No.: US 2022/0108332 A1
(43) Pub. Date: Apr. 7, 2022

(54) Computer System and Method for Music Streaming

(71) Applicant: Terrence Dixon, Gary, IN (US)

(72) Inventor: Terrence Dixon, Gary, IN (US)

(21) Appl. No.: 17/483,154

(22) Filed: Sep. 23, 2021

Related U.S. Application Data
(60) Provisional application No. 63/088,689, filed on Oct. 7, 2020.

(51) Int. Cl. G06Q 30/02; H04L 29/08; G06F 3/16

(52) U.S. Cl. CPC G06Q 30/0201; G06F 3/167; H04L 67/141

(57) ABSTRACT

A computer system and method for music streaming with listening metrics is provided. The system includes a database that is in wireless communication with a plurality of listener-user devices and artist-user devices. The database includes a music streaming service that allows listener-users to access media item that are uploaded by artist-users. The listener-users are presented with a survey to reflect their opinion on a particular media item. The aggregated answers are assigned a number or percentage value based on the total number of listeners and survey participants. The data is presented to the uploading artist-user so that they can gauge the potential popularity of a particular media stem. Additionally, the system is designed to receive the survey data and calculate a marketability or profitability score which is also presented to the artist-user.

### CROSS REFERENCE TO RELATED APPLICATIONS

This application claims the benefit of U.S. Provisional Application No. 63/088,689 filed on Oct. 7, 2020. The above identified patent application is herein incorporated by reference in its entirety to provide continuity of disclosure.

### BACKGROUND Of THE INVENTION

The present invention relates to a computer system and method for music streaming. More specifically, the present invention provides a computer system and method for music streaming that allows a plurality of listener-user devices and artist-user devices to communicate with one another to share and access a media item for the listener-users to evaluate the media item.

With the access that individual artist has to technology to create and produce high quality songs, there are more artists than ever before creating music for listeners to consume. With such a saturated market of music, listeners may be overwhelmed with the amount of music that they can consume. This oversaturation of the music available for listeners makes it difficult for the artists to standout and have their music be consumed by as many listeners as possible. When the level of consumption for a particular artist's music is low, it may be difficult for the artists to know that the music they are producing will be a successful song that people will want to purchase.

Artists want to produce music that they enjoy making and their fans enjoy consuming. Often the artist will want to find the song that their fans enjoy the most. That way the artist can plan on producing additional content around that song to enhance the fan's experience. The artist may choose to take a song that their fans enjoy and produce a music video or if they want to develop a remix of the song. Some artists believe that if they are able to produce more content for a song that is popular, it can enhance the success of the entire album and reach additional number of listeners.

Many artists want to only release music that allows them to stay true to their identity so their loyal fans will want to continue to follow and support them. Therefore, the artists do not want to release undesirable or unpopular music. The artist can damage their reputation and may make it difficult for them to continue in their career if they produce music that is undesired by their listeners. Many musicians rely on social media to determine the likelihood of popularity of certain songs. However, social media may generate inconsistent or inaccurate data for the musician. Without any accurate data reflecting the true impressions of the listeners, a musician may make a poor decision that affects their future endeavors.

Therefore, there is a defined need amongst the known prior art references for a computer system and method for music streaming that connects a plurality of listener-user devices and artist-user devices to communicate and share media files, that provides listener-users with a survey, and provides the artist-user with a statistical analysis of said surveys.

### SUMMARY OF THE INVENTION

In view of the foregoing disadvantages inherent in the known types of computer system and method for music streaming now present in the known art, the present invention provides a new computer system and method for music streaming wherein an artist-user can receive a marketability score and a profitability score based on a survey completed by listener-users.

The present system comprises a database server. The database server includes a processor, a non-transitory computer readable medium, and a logic stored in the non-transitory computer readable medium. With the non-transitory computer readable medium operatively connected to the processor the present system can perform a method for sharing media files. The method for sharing media files comprises the artist uploading the media item into a database and the non-transitory computer readable medium storing the media item for listeners to access. After a listener accesses the media item, a survey is then generated and sent to the listener. Upon reception of the survey, listeners will answer a plurality of questions with a binary yes or no response and depending on the selected answers, the survey will compose data and include a numerical value. All the data and the numerical value will be sent to the artist.

Based upon the findings of the survey and the resulting data, the present system will provide the artist with predictive insight on the reaction of the media item. The accumulation of the surveys performed by the listeners will result in the artist receiving both a marketability and a profitability score. The generated marketability or profitability scores will provide the artist with predictive insight on how the media item will be perceived by individuals upon its release. Such information is based upon the reception of the media item of listeners that utilize the computer system and method for music streaming. In this way, the artist is provided with marketing data and a calculation based on that data in order to make an informed decision before producing and releasing a media item on the marketplace.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a flow chart of an embodiment of the computer system and method for music streaming.

FIG. 2 shows a front view of an embodiment of a display of the computer system and method for music streaming.

FIG. 3 shows a perspective view of an embodiment of a display of the computer system and method for music streaming.

### DETAILED DESCRIPTION OF THE INVENTION

Reference is made herein to the attached drawings. Like reference numerals are used throughout the drawings to depict like or similar elements of the computer system and method for music streaming. The figures are intended for representative purposes only and should not be limiting in any respect.

According to some embodiments, the operations, techniques, and/or components described herein can be implemented as (i) a special-purpose computing device having specialized hardware and a logic hardwired into the computing device to persistently perform the disclosed operations and/or techniques or (ii) a logic that is implementable on an electronic device having a general purpose hardware processor to execute the logic and a non-transitory computer readable medium, e.g. a memory, wherein implementation of the logic by the processor on the electronic device provides the electronic device with the function of a special-purpose computing device.

In the interests of economy, the present disclosure refers to “a non-transitory computer readable medium,” “a processor,” and so on. However, this should not be read as limiting in any way as the present disclosure contemplates embodiments of the present invention utilizing “one or more non-transitory computer readable media,” “one or more processors,” and so on. Unless specifically limited to a single unit, “a” is intended to be equivalent to “one or more” throughout the present disclosure.

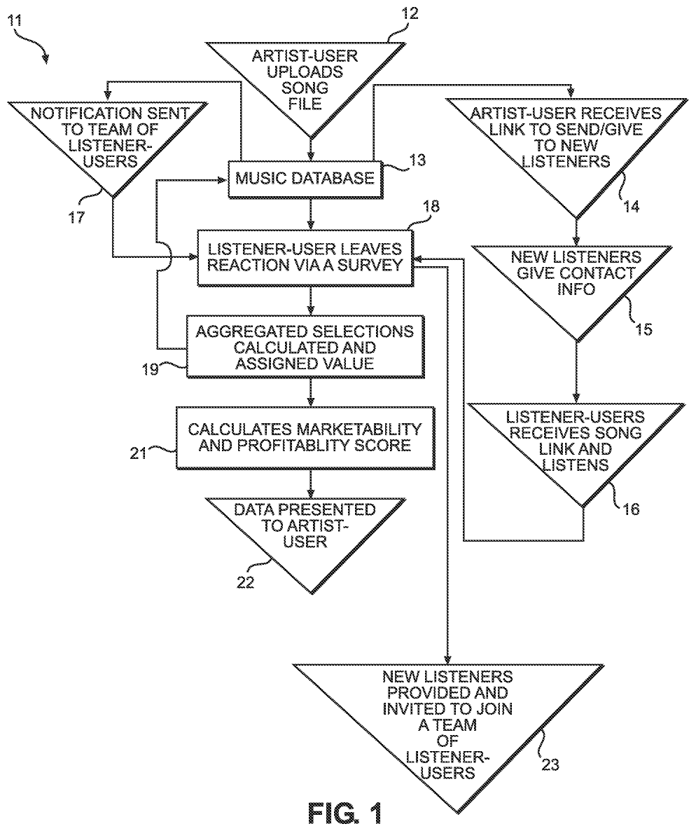

FIG. 1 shows a flow chart of an embodiment of a computer system and method for music streaming. The computer system and method for music streaming 11 incorporates input from artist-users 12 and listener-users 18. The artist-users uploads a file 12 onto a database server 13. In the shown embodiment, the file that the artist-user uploads on to the database server 13 contains a media item. For example, the media item may be an audio file containing a song. The database server 13 comprising a processor, a non-transitory computer readable medium operatively connected to the processor, and a logic stored in the non-transitory computer readable medium that, when executed by the processor, causes the system to perform a method.

Upon the uploading of the media item by the artist-user 12, the listener-user is notified 17 of the newly uploaded file. The listener-users that receive the notification 17 have previously provided their contact information. The contact information may include the listener-user's telephone number or e-mail address. Moreover, the artist-user will receive a link that may be sent to new listeners 14. The new listener-users that receive the link to the database server 13 from the artist-user provide their contact information 15 to become a listener-user that may access the database server 13 and the uploaded file. After the new listener-users provides their contact information 15, the listener-users will receive the link to access the uploaded media item and listen to the media item 16. The newly joined listener-users may link their account with groups of other listener-users that enjoy similar music and artist 23. In this way, the users may receive the notifications 17 when the artist or similar music they enjoy is uploaded by an artist-user 12.

The listener-user will react to the media item that is uploaded by the artist-users after they consume the song. One way that the listener-user will react to the media item is by completing a survey 18. The listener-user will complete the series of questions that are within the survey to accurately express their thoughts to the media item. As more listener-users consume the media item and ultimately complete the reaction survey, all of the survey findings will be aggregated and calculate a value to assign to the media item 19. The calculated and assigned value 19 will be stored in the database server 13 along with the media item. In some embodiments, the listener-user will be compensated after completing the survey. The compensation will encourage all the listener-users to complete the survey so the artist-users can get as much information regarding the reception of the media item as possible.

With the calculated and assigned value 19 that results from listener-users leaving their reactions to uploaded music, in form of a survey 18, the computer system and method for music streaming 11 can provide the user-artist with specific calculations. The computer system and method for music streaming 11 utilizes the calculated and assigned value 19 for a media item to calculate a marketability score and a profitability score 21. The marketability score is a quantifiable value that provides the artist-user with marketing data and a calculation based on that gathered data to allow the artist-user informed decision before releasing the media item on the marketplace. The profitability score is a quantifiable value that provides the artist-user with data that predicts the potential profits that the artist-user may make when the media item is released. The marketability score and the profitability score are determined from the response from the listener-users in the survey 18 being compared to previous media items with similar survey responses that either had from success or failure when produced. The marketability score and the profitability score will be sent to the artist-user 22. With the marketability score and the profitability score, the artist-user will be able to interpret the data and make a prediction on the success that their media item if they consider making their music available for purchase.

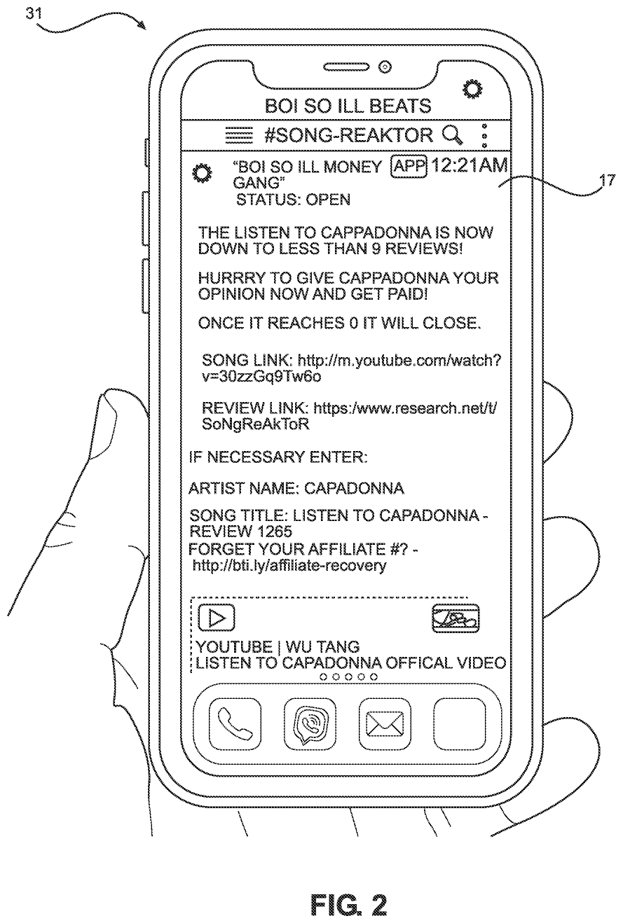

FIG. 2 shows a front view of an embodiment of a display of the computer system and method for music streaming. For a listener-user, they may access the computer system and method for music streaming on an electronic device 31. The listener-user will access the computer system and method for music streaming when an application is launched. A user interface 17 will be displayed on the electronic device when the application is launched.

The user interface 17 provides the user with specific information regarding the media item and a plurality of actionable features. Among the information that is provide to the listener-user on the user interface 17 is the title of the media item, the name of the artist-user that uploaded the media item, and the number of reviews that have been entered for the media item by other listener-users. A first actionable feature of the plurality of actionable features is a song link. When engaged by the listener-user on the user interface 17, the song link will transport the listener-user from the user interface 17 to the media item. When accessing the media item, the listener-user may control the playing of the media item. Specifically, the listener-user may play, pause, fast-forward, or replay the media item to their liking. After the listener-user consumes the media item, they may return to the user interface 17. Once returned to the user interface 17, a second actionable feature of the plurality of actionable features is a review link. When engaged by the listener-user on the user interface 17, the review link will transport the listener-user from the user interface 17 to a survey. When accessing the survey, the listener-user may input responses to the predetermine questions regarding their enjoyment of the media item.

The survey that is filled out by the listener-user following them listening to the media item comprise a plurality of questions. The plurality of questions further includes binary answers. In one embodiment, the listener-user will elect which one of the binary answers accurately reflect their opinion of the media item. When selected, the binary answer of a yes or no answer results in a value being assigned to the media item. As additional listener-users begin to fill out their survey, the values will be aggregated. The aggregated values will calculate a score associated to the media item. The scores that are determined will be provided to the artist-user along with a predictable value on the marketability and the profitability of the media item.

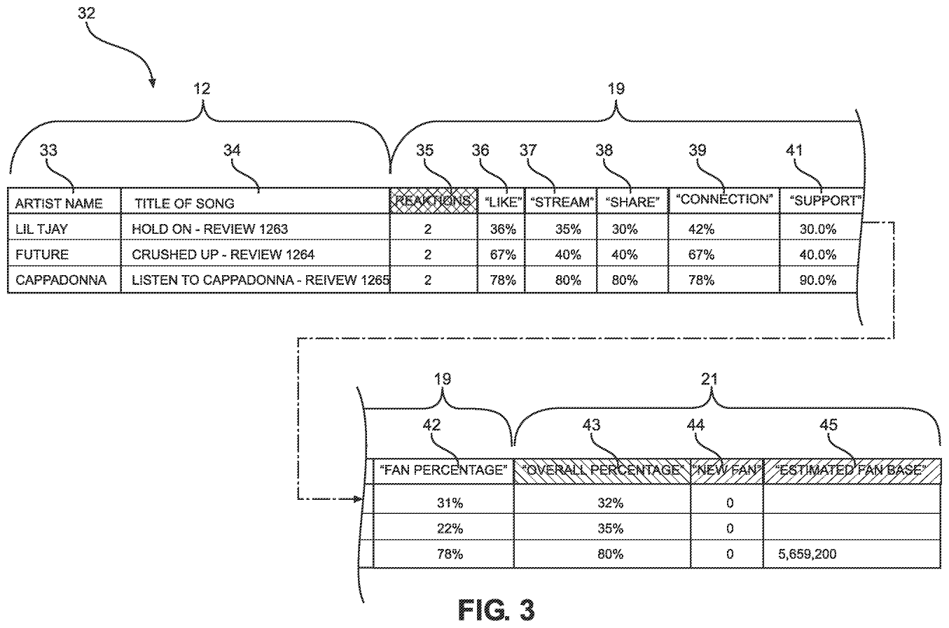

FIG. 3 shows a perspective view of an embodiment of a display of the computer system and method for music streaming. The display of the computer system and method for music streaming 32 allows the artist-user to access and view all of the findings from the listener-user's survey. The display of the computer system and method for music streaming 32 contains identifiable information 12, aggregated data 19, and calculated data 21.

The identifiable information 12 includes an artist's name 33 and a title of the song 34. The identifiable information 12 allows the user to associate the calculated values to the specific media item. The aggregated data 19 includes a plurality of data that is collected based on the collected information on the surveys submitted by the listener-users. First, a listener-user counter 35 is included in the aggregated data 19. The listener-user counter 35 indicates the number of listener-users that have opened the review link and completed the survey.

In the survey, the listener-user will be given a first question of the plurality of questions that asks if the listener-user liked the media item. The survey will include binary answers for the listener-user to select to express their opinion on their likeability of the media item. The results of the surveys will calculate a like-percentage 36. The artist-user will view the cumulative results of all the listener-users surveys in the like-percentage 36 on the display of the computer system and method for music streaming 32.

A second question of the plurality of questions that asks if the listener-user would stream the media item. The survey will include binary answers for the listener-user to select to express their opinion on the chances they stream the media item. The results of the surveys will calculate a stream-percentage 37. The artist-user will view the cumulative results of all the listener-users surveys in the stream-percentage 37 on the display of the computer system and method for music streaming 32.

A third question of the plurality of questions that asks if the listener-user would share the media item to others. The survey will include binary answers for the listener-user to select to express their opinion on the chances they share the media item. The results of the surveys will calculate a share-percentage 38. The artist-user will view the cumulative results of all the listener-users surveys in the share-percentage 38 on the display of the computer system and method for music streaming 32.

A fourth question of the plurality of questions that asks if the listener-user felt a connection to the media item. The survey will include binary answers for the listener-user to select to express their opinion on whether they connected to the media item. The results of the surveys will calculate a connection-percentage 39. The artist-user will view the cumulative results of all the listener-users surveys in the connection-percentage 39 on the display of the computer system and method for music streaming 32.

A fifth question of the plurality of questions that asks if the listener-user would support the media item by purchasing the media item. The survey will include binary answers for the listener-user to select to express their opinion on the chances they would support the media item. The results of the surveys will calculate a support-percentage 41. The artist-user will view the cumulative results of all the listener-users surveys in the support-percentage 41 on the display of the computer system and method for music streaming 32.

The aggregated data 19 reveals a fan-percentage 42 on the display of the computer system and method for music streaming 32. Listener-users may be followers of artist-users. When the artist-users upload any new media item, the listener-users that follow the artist-user will be notified. The listener-users that follow the artist-user that listen to the media item will be displayed as a fan-percentage 42. The artist-user will be able to know how many of their listener-user followers have listen to the media item.

The calculated data 21 shown on the display of the computer system and method for music streaming 32 provides the artist-user with information to help them determine marketability and profitability. The calculated data 21 includes an overall percentage 43. The overall percentage 43 is calculated based upon all of the percentages that were determined in the aggregated data 19. The overall percentage 43 provides the artist-user with a single value of the reception of the media item to determine if the media item will be marketable. The calculated data 21 also includes the number of listener-users that selected to receive notifications from the artist-user as new fans 44 after they have listened to the media item. Moreover, the calculated data 21 will show the artist-user what an algorithm determines will be an estimated number of fans that would enjoy the media item 45. For the artist-user, knowing the estimated number of fans that would enjoy their media item 45 would allow them correctly evaluated the media item's profitability. Specifically, the artist-users will know the probability for success in the marketplace and be capable of making an intelligent, educated decision based on the calculated data 21 as to which media file they want to select as their single, shoot a video for or put on their album.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A computer system, comprising:
an artist device;
at least one listener device;
the artist-user device and the listener-user device in operable connection with a database server;
the database server comprising a processor, a non-transitory computer readable medium operatively connected to the processor, and a logic stored in the non-transitory computer readable medium that, when executed by the processor, causes the system to perform a method, the method comprising:
receiving at the database, from the artist device, a media item;
storing the media item on the non-transitory computer readable medium;
if the media item is accessed by the listener device, then generating and sending a survey to the listener device, each survey comprising a plurality of questions with binary answer values representing a yes or no answer;
receiving, at the database, the survey from the listener device, wherein the survey comprises data corresponding to a number value;
generating a marketability score;
transmitting the marketability score to the artist device.

2. The computer system of claim 1, wherein the non-transitory computer readable medium comprises a listener interface and an artist interface.

3. The computer system of claim 2, wherein the listener interface is accessible on the listener device and artist interface is accessible on the artist device.

4. The computer system of claim 2, whereby the listener interface provides the listener device with access to the media item and the survey, and the artist interface provides the artist device with identifiable information, aggregated data, and calculated data generated from the collection of all of the surveys that the listeners submit.

5. The computer system of claim 1, wherein the data resulting from the survey will be aggregated and calculate the marketability score and a profitability score.

6. The computer system of claim 1, wherein the media item is a music file.

7. The computer system of claim 1, wherein a first question of the plurality of questions is configured to elicit a likeability factor of the user for the media item.

8. The computer system of claim 1, wherein a second question of the plurality of questions is configured to elicit a stream factor of the user for the media item.

9. The computer system of claim 1, wherein a third question of the plurality of questions is configured to elicit a shareability factor of the user for the media item.

10. The computer system of claim 1, wherein a fourth question of the plurality of questions is configured to elicit a connection factor of the user for the media item.

11. The computer system of claim 1, wherein a fifth question of the plurality of questions is configured to elicit a purchase factor of the user for the media item.

12. A method, comprising:
establishing communication between at least one computer system having a non-transitory computer readable median, at least one processor, at least one artist-user device and at least one listener-user device;
registering, by the computer system, existing data from a database server;
registering, by the at least one artist-user device, a media item;
creating a database of media items, each media item comprising a portion of the existing data;
transmitting the media item to at least one listener-user device;
transmitting a survey to at least one listener-user device;
defining the survey with a plurality of questions with binary answer;
receiving the survey with the plurality of questions with binary answer completed from the at least one listener-user device;
analyzing the survey from the at least one listener-user device;
generating, from at least one survey, at least one number value, at least one number value is a marketability score and at least one number value is a profitability score;
transmitting the at least one number value to the artist device.
